(19) United States
(12) Patent Application Publication
(10) Pub. No.: US 2026/0004050 A1
(43) Pub. Date: Jan. 1, 2026

(54) FREEZE ANIMATED IMAGES

(71) Applicant: BrowserStack Limited, Dublin 2 (IE)

(72) Inventors: Amit Singh Sansoya, Punjab (IN); Yash Saraf, Mumbai (IN); Ninad Sheth, Thane (West) (IN); Akshay Minocha, Karnataka (IN)

(21) Appl. No.: 18/756,228

(22) Filed: Jun. 27, 2024

(51) Int. Cl. G06F 40/14; G06F 11/36; G06F 40/221; G06T 13/80

(52) U.S. Cl. CPC G06F 40/14; G06F 11/3696; G06F 40/221; G06T 13/80; G06T 2210/32

(57) ABSTRACT

A system disclosed comprises a processor that performs operations to freeze a webpage loaded on a browser and conduct a test on the webpage, where the operations include to: identify one or more image elements in the webpage by monitoring the webpage using an observer script that monitors the browser for the image elements in the webpage; parse the image elements in respective document object model (DOM) and identify uniform resource locators (URLs) of the parsed image elements; verify whether each parsed image element is freezable; identify media type of the verified image element using the URL of the verified image element; determine width and height of the verified image element; verify image format of the verified image element; convert encoded strings in the image format to corresponding Uniform Resource Identifier (URI) data of the image element; and modify actual elements in the DOM based on the URI data.

### TECHNICAL FIELD

The present invention relates to a field of computer technologies, especially to the field of imaging technologies, and in particular, a system and an associated method that effectively freezes moving images in a webpage and renders the same freezed image on repeated freezing operations.

### BACKGROUND

Background description includes information that may be useful in understanding the present invention. It is not an admission that any of the information provided herein is prior art or relevant to the presently disclosed invention, or that any publication specifically or implicitly referenced is prior art.

A very important part of visual testing is the stability of the webpage being tested. Any instability in the page, be it animated images, videos, css, animations etc. can cause the page to get rendered differently than the previous instance and highlight unintentional flakes. In other words, animated images such as svgs, gifs, avif, apng, etc., causes problem in terms of stability when a screenshot is taken. For example, if a user takes 2 screenshots of the same website at different times which has animated images, then the user will see few differences even though the website appears to be same when looked upon. This is because the images don't get frozen and every time a screenshot is taken a different frame of image is captured in the screenshot which causes the difference.

Therefore, there is a need for a method and a system that effectively freezes moving images in a webpage and renders the same freezed image whenever the freezing operation is performed. During the process of analyzing this above-mentioned problem, there were some constraints that needed to be considered:
1) Webpages contain animated images. There can be multiple animated images and all of them should be freezed. In other words, there are various types of animated images not just one and the goal is to hide all the possible types.
2) The freezing of the page needs to be consistent, and the same frame should be visible every time the user freezes something. This basically means that every time the animation is freezed, the frame of image and results obtained needs to be consistent.
3) Various animated image formats such as svg, webp, gif need to be supported.
4) The intended solution needs to be browser independent. For example, the solution proposed should be generic enough that it runs on all browsers+platforms, i.e. desktop browsers (chromium, Firefox, safari)+mobile browsers. The solution should be extensible and should be working for all the browsers.

### SUMMARY OF THE INVENTION

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

As used herein:
The phrase “Document Object Model (DOM)” connects webpages to scripts or programming languages by representing the structure of a document. such as the HTML representing a webpage—in memory. Usually it refers to JavaScript, even though modeling HTML, SVG, or XML documents as objects are not part of the core JavaScript language. The DOM represents a document with a logical tree.
The term “MutationObserver” interface provides the ability to watch for changes being made to the DOM tree. It is designed as a replacement for the older Mutation Events feature, which was part of the DOM3 Events specification.
The term “MimeType” is a media type (also known as a Multipurpose Internet Mail Extensions or MIME type) indicates the nature and format of a document, file, or assortment of bytes. MIME types are defined and standardized in IETF's RFC 6838.

A system disclosed herein addresses the above-mentioned need to effectively freeze moving images in a webpage and to render the same freezed image whenever the freezing operation is performed. To understand the solution described in this disclosure, appearance of an animated image on the webpage is studied. As shown in FIG. 1A, if this image is on a webpage and a screenshot is taken, then this image appears differently on different frames. However, if the expected output of the above image in a screen shot, if taken 1000 times as well should be same to generate a stable screenshot. Therefore, once the image is freezed the output of the image appears as in FIG. 2B, a constant image at the very first frame. Now, if the screenshot of this animated image is run with the proposed script the output remains constant. The frozen animated image is as shown in FIG. 2B.

Points to be noted during the method involves:
All the elements which can be used to display images in a webpage should be traversed and frozen.
Identify the origin of the images on the webpage.
Elements already in the page, and the ones getting dynamically added while rendering should be handled.

In view of the above, the system disclosed comprises a processor that performs operations to freeze a webpage loaded on a browser and conduct a test on the webpage, where the operations include to: identify one or more image elements in the webpage by monitoring the webpage using an observer script that monitors the browser for the image elements in the webpage; parse the image elements in respective document object model (DOM) and identify uniform resource locators (URLs) of the parsed image elements; verify whether each parsed image element is freezable; identify media type of the verified image element using the URL of the verified image element; determine width and height of the verified image element; verify image format of the verified image element; convert encoded strings in the image format to corresponding Uniform Resource Identifier (URI) data of the image element; and modify actual elements in the DOM based on the URI data.

In an embodiment, the image format is a Scalable Vector Graphics (svg) format, where the verification is performed regarding whether the verified image element is one of an svg image element and a non-svg image element. In an embodiment, system further comprises identification of media type of the verified image element using actual file content and headers associated with the verified image element. In an embodiment, when the verified image element is an svg image element, the processor is configured to: verify whether the svg image element includes utf-8 encoding; load the image from the URL if utf-8 encoding is absent; parse the DOM; and parse associated extensible markup language (XML) DOM tree, which is followed by conversion of the encoded strings in the image format to the URI data of the image element.

In an embodiment, when the svg image element does not include utf-8 encoding, the image element is freezed in the browser by removing animatable Cascading Style Sheets (CSS) and attributes from the DOM Tree and is converted to the encoded strings, which is followed by conversion of the encoded strings in the image format to a PNG (Portable Network Graphics) format that includes the URI data of the image element. In an embodiment, the svg image element is base64 encoded, where the base64 encoded svg image element is converted to an svg string to remove the animatable CSS and attributes. In an embodiment, when the svg image element does include utf-8 encoding, then the svg image element is decoded to remove the animatable CSS and attributes.

In an embodiment, the system further comprising retrieving an actual image of the svg image element using URL and remove the animatable CSS and attributes from the retrieved actual image. In an embodiment, when the verified image element is a non-svg image element, the processor is configured to: load the image element from the URL; draw an empty canvas with the determined width and height of the verified image element; and draw the image element on the canvas, which is followed by conversion of the encoded strings in the image format to the PNG format comprising the URI data of the image element. In an embodiment, the observer script is a MutationObserver configured to monitor the DOM for new image elements that are added or modified, where the MutationObserver chooses eligible animated images that needs to be marked for the freezing.

These and other objects, embodiments and advantages of the present invention will become readily apparent to those skilled in the art from the following detailed description of the embodiments having reference to the attached figures, the invention not being limited to any particular embodiments disclosed.

### BRIEF DESCRIPTION OF FIGURES

The foregoing and further objects, features and advantages of the present subject matter will become apparent from the following description of exemplary embodiments with reference to the accompanying drawings, wherein like numerals are used to represent like elements.

It is to be noted, however, that the appended drawings along with the reference numerals illustrate only typical embodiments of the present subject matter, and are therefore, not to be considered for limiting its scope, for the subject matter may admit to other equally effective embodiments.

FIG. 1A exemplarily illustrates the image on the webpage before the screenshot, as an example embodiment of the present disclosure.

FIG. 1B exemplarily illustrates the image on the webpage after the screenshot, as an example embodiment of the present disclosure.

FIG. 2 exemplarily illustrates a schematic flow of the steps that are involved in the system and associated method with performing operations using a processor to freeze a webpage loaded on a browser and conduct a test on the webpage, as an example embodiment of the present disclosure.

FIG. 3A exemplarily illustrates a flow chart of the system and associated method with performing operations using a processor to freeze a webpage loaded on a browser to conduct the test on the webpage, as an example embodiment of the present disclosure.

FIG. 3B exemplarily illustrates, for the purpose of clearer illustration of FIG. 3A, a portion marked “X” of the flow chart of the system and associated method as shown in FIG. 3A, as an example embodiment of the present disclosure.

FIG. 3C exemplarily illustrates, for the purpose of clearer illustration of FIG. 3A, a portion marked “Y” of the flow chart of the system and associated method as shown in FIG. 3A, as an example embodiment of the present disclosure.

FIG. 4 is a block diagram that illustrates a computer system upon which embodiments of the system can be implemented, where the system performs operations to freeze a webpage loaded on a browser and conducts a test on the webpage.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

It is to be noted, however, that the reference numerals used herein illustrate only typical embodiments of the present subject matter, and are therefore, not to be considered for limiting its scope, for the subject matter may admit to other equally effective embodiments.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skills in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

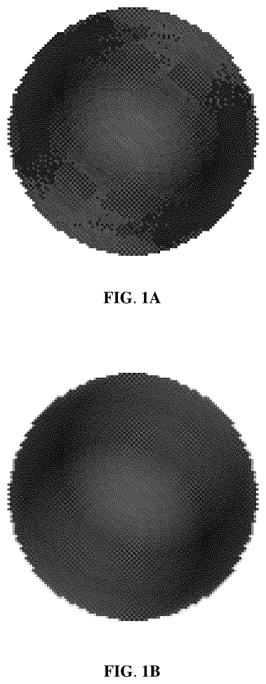

Referring to FIGS. 1A-1B, FIG. 1A exemplarily illustrates the image on the webpage 302 before the screenshot, and FIG. 1B exemplarily illustrates the image on the webpage 302 after the screenshot, as an example embodiment of the present disclosure. In an example, FIG. 1A shows how an animated image appears on a webpage 302. If this image is on the webpage 302 and a screenshot is taken, then this particular image will appear different on different frames. From a solution standpoint, even if we take the screenshot more than 1000 times, the expected output of the above image should be same to generate a stable screenshot. Based on the proposed solution, once the image is freezed the output of the image appear as FIG. 1B, a constant image at the very first frame. And if the screenshot is taken of this animated image running with our script the output will always be constant. FIG. 1B shows how a freezed animated image looks like. From a coverage standpoint of the present disclosure, all the elements which can be used to display images in a webpage 302 should be traversed and frozen, origin of the images are identified on the webpage 302, and elements that are already in the webpage 302, and the ones getting dynamically added while rendering needs to be addressed.

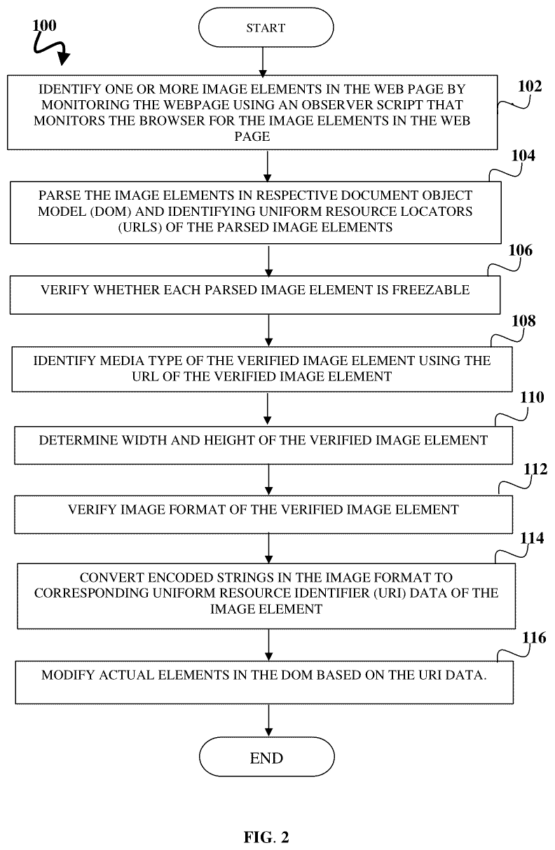

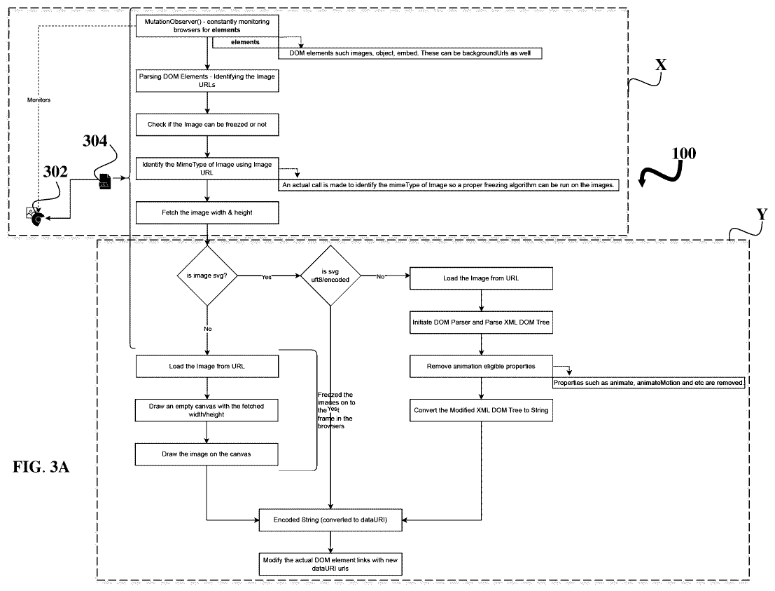

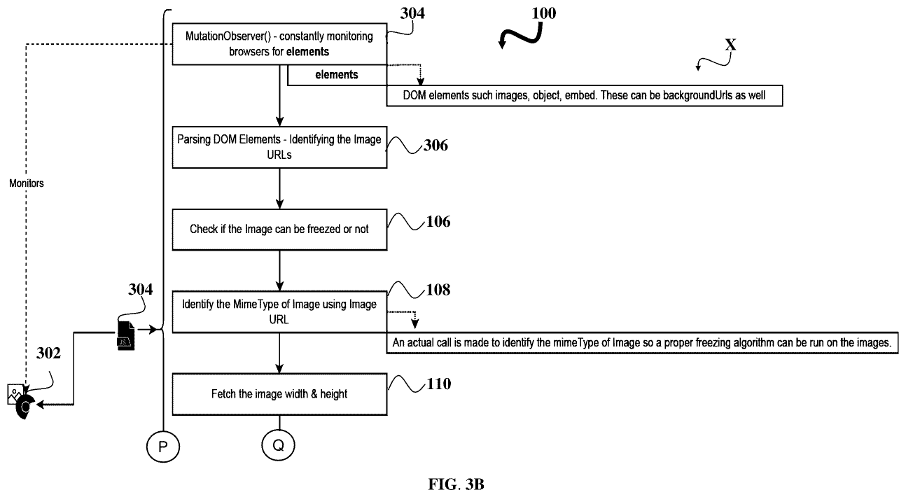

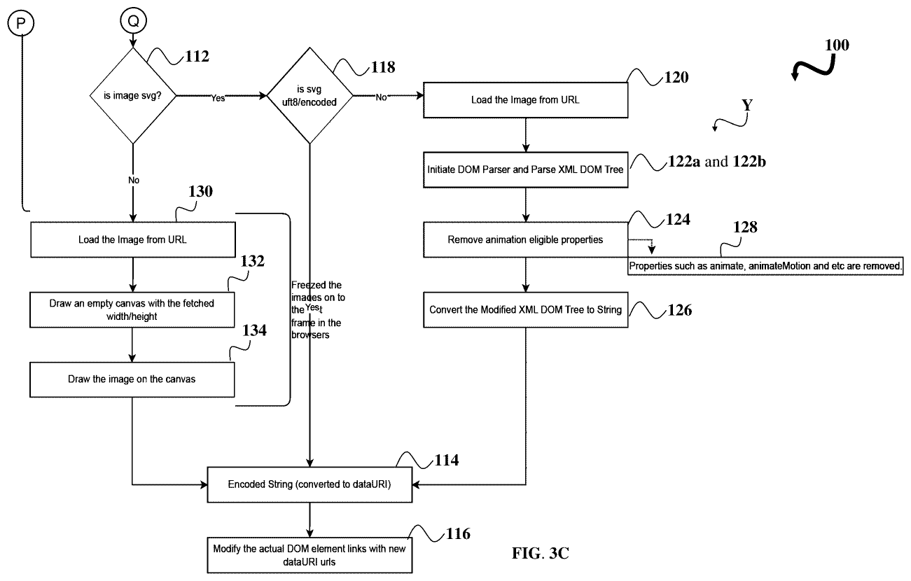

Referring to FIGS. 2, 3A, 3B, and 3C, FIG. 2 exemplarily illustrates a schematic flow of the steps that are involved in the system 100 and associated method of performing operations using a processor 1004 to freeze a webpage 302 loaded on a browser and conduct a test on the webpage 302, as an example embodiment of the present disclosure.

FIG. 3A exemplarily illustrates a flow chart of the system 100 and associated method with performing operations using a processor to freeze a webpage 302 loaded on a browser to conduct the test on the webpage 302, as an example embodiment of the present disclosure. FIG. 3B exemplarily illustrates, for the purpose of clearer illustration of FIG. 3A, a portion marked “X” of the flow chart of the system and associated method as shown in FIG. 3A, as an example embodiment of the present disclosure. FIG. 3C exemplarily illustrates, for the purpose of clearer illustration of FIG. 3A, a portion marked “Y” of the flow chart of the system and associated method as shown in FIG. 3A, as an example embodiment of the present disclosure.

As shown in FIGS. 2, 3A, 3B, the system 100 comprises a processor 1004 configured to perform operations to freeze a webpage 302 loaded on a browser and conduct a test on the webpage 302, wherein the operations include the following method steps:
Step 1: identify 102 one or more image elements in the webpage 302 by monitoring the webpage 302 using an observer script 304 that monitors the browser for the image elements in the webpage 302. The MutationObserver ( ) constantly monitors browser for elements. The DOM elements include, for example, images, embedded objects, background URLs etc.
Step 2: parse 104 the image elements in respective document object model (DOM) 306 and identify uniform resource locators (URLs) of the parsed image elements, or in other words, parsing DOM elements and identifying image URLs.
Step 3: verify 106 whether each parsed image element is freezable, or to check if the image can be freezed or not.
Step 4: identify 108 media type (Mime type) of the verified image element using the URL of the verified image element. In other words, identify the mime type of the image using the image URL. In an embodiment, an actual call is made to identify the mime type of the image to that a proper freezing algorithm can be run on the images.
Step 5: determine 110 or fetch the width and height of the verified image element.
Step 6: verify 112 image format of the verified image element. In an embodiment, the image format is a Scalable Vector Graphics (svg) format, wherein the verification 112 is performed regarding whether the verified image element is one of an svg image element and a non-svg image element.
Step 7: convert 114 encoded strings in the image format to corresponding Uniform Resource Identifier (URI) data of the image element.
Step 8: modify 116 actual elements in the DOM 306 based on the URI data. In other words, modifying the actual DOM element links with new data URLs.

The system 100 further comprises identification of media type of the verified image element using actual file content and headers associated with the verified image element. In an embodiment, when the verified image element is an svg image element, the processor 1004 is configured to: Step (a): verify 118 whether the svg image element includes utf-8 encoding, Step (b): load 120 the image from the URL if utf-8 encoding is absent, and Step (c) parse 122a the DOM 306 and parse 122b associated extensible markup language (XML) DOM 306 tree, which is followed by conversion of the encoded strings in the image format to the URI data of the image element. In an embodiment, when the svg image element does not include utf-8 encoding, the image element is freezed in the browser by removing 124 animatable Cascading Style Sheets (CSS) and attributes from the DOM 306 Tree and is converted 126 to the encoded strings, which is followed by conversion of the encoded strings in the image format to a PNG (Portable Network Graphics) format that includes the URI data of the image element. Properties such as animate, animate motion, etc., are removed.

In an embodiment, when the svg image element is base64 encoded, wherein the base64 encoded svg image element is converted 128 to an svg string to remove the animatable CSS and attributes. When the svg image element does include utf-8 encoding, then the svg image element is decoded to remove the animatable CSS and attributes. The system 100 further comprises the retrieval of an actual image of the svg image element using URL and removal of the animatable CSS and attributes from the retrieved actual image. In case when the when the verified image element is a non-svg image element, the processor 1004 is configured to: Step (1a) load 130 the image element from the URL, Step (2a): draw 132 an empty canvas with the determined of fetched width and height of the verified image element, and Step (3a): draw 134 the image element on the canvas, which is followed by conversion of the encoded strings in the image format to the PNG format comprising the URI data of the image element.

In an embodiment, the observer script 304 is a MutationObserver configured to monitor the DOM 306 for new image elements that are added or modified, where the MutationObserver chooses eligible animated images that needs to be marked for the freezing. Identification of the image elements require a methodology, where the MutationObserver monitors the DOM 306 for new elements which are getting added. If there are any eligible animated images that should get marked for the freezing. Eligible nodes are traversed further like shadowRoot elements or Iframes. If these particular elements are img, embed or object and other eligible elements then the element is processed for freezing them out. This fetches the images from the backgroundURL or other equivalent properties as well such as ‘src’. Also, in addition to this, all the web elements present in DOM 306 are observed as any web element can have the background URL properties. Therefore, in order to ensure that to make sure that apart from the above elements, all the elements of DOM 306 are verified to ensure whether all the background images are being applied on it or not. If they are applied, then that particular URL is added for further processing. This also goes through complex background parser properties where backgroundURL can have multiple URLs as multiple images can be set. In such cases the URLs are split, and then iteration is performed over all the URLs. All the URLs are parsed for proper bracket openings (and last closing bracket).

In order to understand the background parser, the background URL which is represented in the DOM 306 can be complex as a user can provide image by providing a single URL or a combination of multiple URLs. However, while freezing all the images need to be identified individually and freezed individually so that collectively they appear frozen on the DOM 306.

To identify all the URLs present in the DOM 306 in a single attribute of background-image, it goes through little complex part. Here are the steps below for the same:
The system 100 has to go through the property of background images and split them at (url(,). This provides us the list of URL which can be present in that single attribute.
The user needs to iterate over each URL item and parse them with the regex where we identify the proper url (“-abcd-”) pattern and return them as single image to the rest of the process so it can freeze it.

To identify the images that need to be frozen, the following steps are used:
When processing the elements there are set of rules which are processed to make sure proper freezing algorithm is being run on the images.
Identify the correct mimetype of image.
   These generally resolves to following for various animated images
   image/gif
   image/svg+xml
   image/apng
   image/webp
   text/xml
   image/png
   image/avif
Load the actual image from the actual image URL and fetch the height and width from the actual image. This is important because the actual height and width of the loaded image might differ.

The freezing operation involves the following steps:

If the image is not an SVG then, this basically means that the first frame of the image is fetched or determined, which ensures that the animated images are freezed.
Load the image.
Draw an empty canvas with the size of the image.
Draw the image on to the canvas and covert to dataURL.
Else if it's an SVG image then,
Identify the type of SVG
If its svg+xml encoded url or utf-8 encoded URL we don't need to do much about it.
Or Else
   Fetch the image from URL.
   Initiate the DOM Parser
   As an XML Parser fetch the DOM Tree
   From the DOM Tree remove the nodes containing following properties
      Animate
      animatemotion
      animateTransform
Convert back Modified Tree to String
Convert it into encoded URL.

Finally, a frozen image is obtained that is set to the required properties of the identified nodes, and in a browser, these will appear as non-animated. The script is run across browsers in two ways, for example, as a JS as a part of script tag which runs in the browsers. In certain cases, the JS is disabled, where the script in run via extensions in browsers. Since the extensions can run JS they can trigger and make the changes. In the whole process the user needs to ensure that properties, for example, srcset is not set to make sure that the actual sources are always set. Similarly, the user needs to ensure that the Picture tag, or other equivalent tags are properly set.

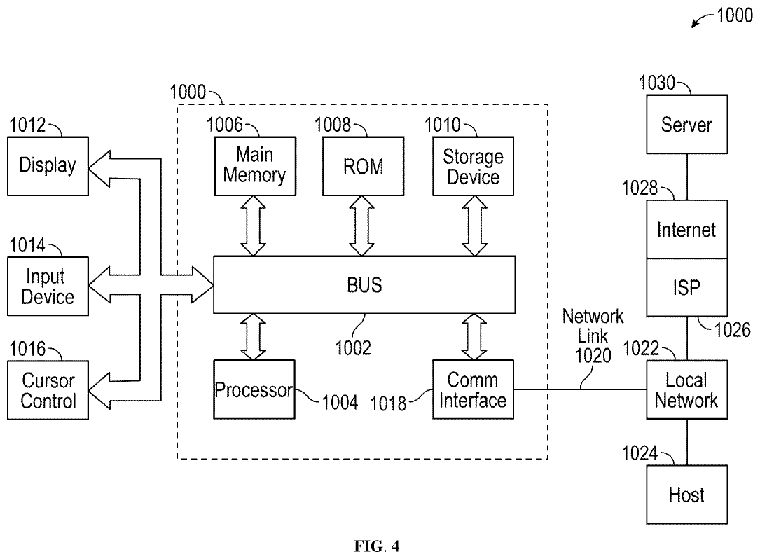

FIG. 4 is a block diagram that illustrates a computer system upon which embodiments of the system can be implemented, where the system performs operations to freeze a webpage 302 loaded on a browser and conducts a test on the webpage 302. Example Implementation Mechanism-Hardware Overview: Some embodiments are implemented by a computer system or a network of computer systems. A computer system may include a processor, a memory, and a non-transitory computer-readable medium. The memory and non-transitory medium may store instructions for performing methods, steps and techniques described herein.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be server computers, cloud computing computers, desktop computer systems, portable computer systems, handheld devices, networking devices or any other device that incorporates hard-wired and/or program logic to implement the techniques.

For example, FIG. 4 is a block diagram that illustrates a computer system 1000 that performs operations using a processor 1004 to freeze a webpage 302 loaded on a browser and conduct a test on the webpage 302, can be implemented. Computer system 1000 includes a bus 1002 or other communication mechanism for communicating information, and a hardware processor 1004 coupled with bus 1002 for processing information. Hardware processor 1004 may be, for example, special-purpose microprocessor optimized for handling audio and video streams generated, transmitted, or received in video conferencing architectures. Computer system 1000 also includes a main memory 1006, such as a random-access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid state disk is provided and coupled to bus 1002 for storing information and instructions. Computer system 1000 may be coupled via bus 1002 to a display 1012, such as a cathode ray tube (CRT), liquid crystal display (LCD), organic light-emitting diode (OLED), or a touchscreen for displaying information to a computer user. An input device 1014, including alphanumeric and other keys (e.g., in a touch screen display) is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some embodiments, the user input device 1014 and/or the cursor control 1016 can be implemented in the display 1012 for example, via a touch-screen interface that serves as both output display and input device.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical, magnetic, and/or solid-state disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media. Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, and/or stored in storage device 1010, or other non-volatile storage for later execution.

### EXAMPLES

It will be appreciated that the present disclosure may include any one and up to all of the following examples.

Example 1: A system comprising a processor, the processor configured to perform operations to freeze a webpage loaded on a browser and conduct a test on the webpage, wherein the operations include to: identify one or more image elements in the webpage by monitoring the webpage using an observer script that monitors the browser for the image elements in the webpage; parse the image elements in respective document object model (DOM) and identify uniform resource locators (URLs) of the parsed image elements; verify whether each parsed image element is freezable; identify media type of the verified image element using the URL of the verified image element; determine width and height of the verified image element; verify image format of the verified image element; convert encoded strings in the image format to corresponding Uniform Resource Identifier (URI) data of the image element; and modify actual elements in the DOM based on the URI data.

Example 2: The system of example 1, wherein the image format is a Scalable Vector Graphics (svg) format, wherein the verification is performed regarding whether the verified image element is one of an svg image element and a non-svg image element.

Example 3: The system of some or all of Examples 1 and 2, further comprising identification of media type of the verified image element using actual file content and headers associated with the verified image element.

Example 4: The system of some or all of Examples 1-3, wherein when the verified image element is an svg image element, the processor is configured to: verify whether the svg image element includes utf-8 encoding; load the image from the URL if utf-8 encoding is absent; parse the DOM; and parse associated extensible markup language (XML) DOM tree, which is followed by conversion of the encoded strings in the image format to the URI data of the image element.

Example 5: The system of some or all of Examples 1-4, wherein when the svg image element does not include utf-8 encoding, the image element is freezed in the browser by removing animatable Cascading Style Sheets (CSS) and attributes from the DOM Tree and is converted to the encoded strings, which is followed by conversion of the encoded strings in the image format to a PNG (Portable Network Graphics) format that includes the URI data of the image element.

Example 6: The system of some or all of Examples 1-5, wherein the svg image element is base64 encoded, wherein the base64 encoded svg image element is converted to an svg string to remove the animatable CSS and attributes.

Example 7: The system of some or all of Examples 1-6, wherein when the svg image element does include utf-8 encoding, then the svg image element is decoded to remove the animatable CSS and attributes.

Example 8: The system of some or all of Examples 1-7, further comprising retrieving an actual image of the svg image element using URL and remove the animatable CSS and attributes from the retrieved actual image.

Example 9: The system of some or all of Examples 1-8, wherein when the verified image element is a non-svg image element, the processor is configured to: load the image element from the URL; draw an empty canvas with the determined width and height of the verified image element; and draw the image element on the canvas, which is followed by conversion of the encoded strings in the image format to the PNG format comprising the URI data of the image element.

Example 10: The system of some or all of Examples 1-9, wherein the observer script is a MutationObserver configured to monitor the DOM for new image elements that are added or modified, wherein the MutationObserver chooses eligible animated images that needs to be marked for the freezing.

Example 11: A method to perform operations using a processor to freeze a webpage loaded on a browser and conduct a test on the webpage, wherein the operations include to: identifying one or more image elements in the webpage by monitoring the webpage using an observer script that monitors the browser for the image elements in the webpage; parsing the image elements in respective document object model (DOM) and identifying uniform resource locators (URLs) of the parsed image elements; verifying whether each parsed image element is freezable; identifying media type of the verified image element using the URL of the verified image element; determining width and height of the verified image element; verifying image format of the verified image element; converting encoded strings in the image format to corresponding Uniform Resource Identifier (URI) data of the image element; and modifying actual elements in the DOM based on the URI data.

Example 12: The method of example 11, wherein the image format is an svg format, wherein the verification is performed regarding whether the verified image element is one of an svg image element and a non-svg image element.

Example 13: The method of some or all of Examples 11 and 12, further comprising identification of media type of the verified image element using actual file content and headers associated with the verified image element.

Example 14: The method of some or all of Examples 11-13, wherein if the verified image element is an svg image element, the processor performs operations comprising: verifying whether the svg image element includes utf-8 encoding; loading the image from the URL if utf-8 encoding is absent; parsing the DOM; and parsing associated XML DOM tree, which is followed by conversion of the encoded strings in the image format to the URI data of the image element.

Example 15: The method of some or all of Examples 11-14, wherein when the svg image element does not include utf-8 encoding, the image element is freezed in the browser by removing animatable CSS and attributes from the DOM Tree and is converted to the encoded strings, followed by the conversion of the encoded strings in the image format to corresponding PNG format comprising the URI data of the image element.

Example 16: The method of some or all of Examples 11-15, wherein when the verified image element is a non-svg image element, the processor performs operations comprising: loading the image element from the URL; drawing an empty canvas with the determined width and height of the verified image element; and drawing the image element on the canvas, which is followed by conversion of the encoded strings in the image format to the PNG format comprising the URI data of the image element.

Example 17: The method of some or all of Examples 11-16, wherein the observer script is a MutationObserver to monitor the DOM for new image elements that are added or modified, wherein the MutationObserver chooses eligible animated images that needs to be marked for the freezing.

Example 18: A non-transitory computer storage that stores executable program instructions that, when executed by one or more computing devices, configure the one or more computing devices to perform operations freeze a webpage loaded on a browser and conduct a test on the webpage, the operations comprising: identifying one or more image elements in the webpage by monitoring the webpage using an observer script that monitors the browser for the image elements in the webpage; parsing the image elements in respective document object model (DOM) and identifying uniform resource locators (URLs) of the parsed image elements; verifying whether each parsed image element is freezable; identifying media type of the verified image element using the URL of the verified image element; determining width and height of the verified image element; verifying image format of the verified image element; converting encoded strings in the image format to corresponding Uniform Resource Identifier (URI) data of the image element; and modifying actual elements in the DOM based on the URI data.

It will be understood that each block of the block diagrams can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the drawings and specification, there have been disclosed exemplary embodiments of the invention. Although specific terms are employed, they are used in a generic and descriptive sense only and not for purposes of limitation of the scope of the invention.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

We claim:

1. A system comprising a processor, the processor configured to perform operations to freeze a webpage loaded on a browser and conduct a test on the webpage, wherein the operations include to:
identify one or more image elements in the webpage by monitoring the webpage using an observer script that monitors the browser for the image elements in the webpage;
parse the image elements in respective document object model (DOM) and identify uniform resource locators (URLs) of the parsed image elements;
verify whether each parsed image element is freezable;
identify media type of the verified image element using the URL of the verified image element;
determine width and height of the verified image element;
verify image format of the verified image element;
convert encoded strings in the image format to corresponding Uniform Resource Identifier (URI) data of the image element; and
modify actual elements in the DOM based on the URI data.

2. The system as claimed in claim 1, wherein the image format is a Scalable Vector Graphics (svg) format, wherein the verification is performed regarding whether the verified image element is one of an svg image element and a non-svg image element.

3. The system as claimed in claim 1, further comprising identification of media type of the verified image element using actual file content and headers associated with the verified image element.

4. The system as claimed in claim 2, wherein when the verified image element is an svg image element, the processor is configured to:
verify whether the svg image element includes utf-8 encoding;
load the image from the URL if utf-8 encoding is absent;
parse the DOM; and
parse associated extensible markup language (XML) DOM tree, which is followed by conversion of the encoded strings in the image format to the URI data of the image element.

5. The system as claimed in claim 4, wherein when the svg image element does not include utf-8 encoding, the image element is freezed in the browser by removing animatable Cascading Style Sheets (CSS) and attributes from the DOM Tree and is converted to the encoded strings, which is followed by conversion of the encoded strings in the image format to a PNG (Portable Network Graphics) format that includes the URI data of the image element.

6. The system as claimed in claim 4, wherein the svg image element is base64 encoded, wherein the base64 encoded svg image element is converted to an svg string to remove the animatable CSS and attributes.

7. The system as claimed in claim 5, wherein when the svg image element does include utf-8 encoding, then the svg image element is decoded to remove the animatable CSS and attributes.

8. The system as claimed in claim 6, further comprising retrieving an actual image of the svg image element using URL and remove the animatable CSS and attributes from the retrieved actual image.

9. The system as claimed in claim 2, wherein when the verified image element is a non-svg image element, the processor is configured to:
load the image element from the URL;
draw an empty canvas with the determined width and height of the verified image element; and
draw the image element on the canvas, which is followed by conversion of the encoded strings in the image format to the PNG format comprising the URI data of the image element.

10. The system as claimed in claim 1, wherein the observer script is a MutationObserver configured to monitor the DOM for new image elements that are one of added and modified, wherein the MutationObserver chooses eligible animated images that needs to be marked for the freezing.

11. A method to perform operations using a processor to freeze a webpage loaded on a browser and conduct a test on the webpage, wherein the operations include to:
identifying one or more image elements in the webpage by monitoring the webpage using an observer script that monitors the browser for the image elements in the webpage;
parsing the image elements in respective document object model (DOM) and identifying uniform resource locators (URLs) of the parsed image elements;
verifying whether each parsed image element is freezable;
identifying media type of the verified image element using the URL of the verified image element;
determining width and height of the verified image element;
verifying image format of the verified image element;
converting encoded strings in the image format to corresponding Uniform Resource Identifier (URI) data of the image element; and
modifying actual elements in the DOM based on the URI data.

12. The method as claimed in claim 11, wherein the image format is an svg format, wherein the verification is performed regarding whether the verified image element is one of an svg image element and a non-svg image element.

13. The method as claimed in claim 11, further comprising identification of media type of the verified image element using actual file content and headers associated with the verified image element.

14. The method as claimed in claim 12, wherein if the verified image element is an svg image element, the processor performs operations comprising:
verifying whether the svg image element includes utf-8 encoding;
loading the image from the URL if utf-8 encoding is absent;
parsing the DOM; and
parsing associated XML DOM tree, which is followed by conversion of the encoded strings in the image format to the URI data of the image element.

15. The method as claimed in claim 12, wherein when the svg image element does not include utf-8 encoding, the image element is freezed in the browser by removing animatable CSS and attributes from the DOM Tree and is converted to the encoded strings, followed by the conversion of the encoded strings in the image format to corresponding PNG format comprising the URI data of the image element.

16. The method as claimed in claim 12, wherein when the verified image element is a non-svg image element, the processor performs operations comprising:
loading the image element from the URL;
drawing an empty canvas with the determined width and height of the verified image element; and
drawing the image element on the canvas, which is followed by conversion of the encoded strings in the image format to the PNG format comprising the URI data of the image element.

17. The method as claimed in claim 11, wherein the observer script is a MutationObserver to monitor the DOM for new image elements that are one of added and modified, wherein the MutationObserver chooses eligible animated images that needs to be marked for the freezing.

18. A non-transitory computer storage that stores executable program instructions that, when executed by one or more computing devices, configure the one or more computing devices to perform operations freeze a webpage loaded on a browser and conduct a test on the webpage, the operations comprising:
identifying one or more image elements in the webpage by monitoring the webpage using an observer script that monitors the browser for the image elements in the webpage;
parsing the image elements in respective document object model (DOM) and identifying uniform resource locators (URLs) of the parsed image elements;
verifying whether each parsed image element is freezable;
identifying media type of the verified image element using the URL of the verified image element;
determining width and height of the verified image element;
verifying image format of the verified image element;
converting encoded strings in the image format to corresponding Uniform Resource Identifier (URI) data of the image element; and
modifying actual elements in the DOM based on the URI data.
